(19) United States
(12) Patent Application Publication
(10) Pub. No.: US 2026/0351854 A1
(43) Pub. Date: Nov. 5, 2026

(54) FOLDED HORN ANTENNA

(71) Applicant: Qorvo US, Inc., Greensboro, NC (US)

(72) Inventor: Jan-Willem Zweers, Nieuwleusen (NL)

(21) Appl. No.: 19/532,581

(22) Filed: Feb. 6, 2026

Related U.S. Application Data
(60) Provisional application No. 63/790,897, filed on Apr. 18, 2025.
(60) Provisional application No. 63/845,743, filed on Jul. 17, 2025.

(51) Int. Cl. H01Q 13/02; H01Q 5/20

(52) U.S. Cl. CPC H01Q 13/0275; H01Q 5/20

(57) ABSTRACT

A folded-edge horn antenna is disclosed. In one aspect, a traditional Vivaldi horn antenna may be fitted into a smaller space by folding the tapered void of the horn antenna. Further, the folded horn antenna may be positioned inside the boundaries of a ground plane such that an edge of the ground plane acts to extend an effective aperture of the antenna, thereby expanding the frequency range over which the antenna may operate.

### RELATED APPLICATIONS

The present application is related to U.S. Provisional Patent Application Ser. No. 63/790,897 filed on Apr. 18, 2025, and entitled “FOLDED EDGE ENABLED SUPER (FEEST) TINY HORN ANTENNA,” and U.S. Provisional Application Ser. No. 63/845,743 filed on Jul. 17, 2025, and entitled “FOLDED HORN ANTENNA” the disclosures of which are incorporated herein by reference in their entireties.

### BACKGROUND

### I. Field of the Disclosure

The technology of the disclosure relates generally to an antenna, and particularly, to a small-sized horn antenna.

### II. Background

Computing devices abound in modern society, and more particularly, mobile communication devices have become increasingly common. The prevalence of these mobile communication devices is driven in part by the many functions that are now enabled on such devices. While smartphones and wearable devices frequently take the majority of consumer attention, the wireless communication device industry is much wider. The automotive industry, in particular, is increasingly reliant on wireless devices that send and receive signals for a variety of purposes. With each wireless communication device, there is at least one antenna and usually multiple antennas provided to send and receive signals. Providing such antennas in the face of size constraint pressure provides room for innovation.

### SUMMARY

Aspects disclosed in the detailed description include a folded-edge horn antenna. In particular, a traditional Vivaldi horn antenna may be fitted into a smaller space by folding the tapered void of the horn antenna. Further, the folded horn antenna may be positioned inside the boundaries of a ground plane such that an edge of the ground plane acts to extend an effective aperture of the antenna, thereby expanding the frequency range over which the antenna may operate.

In this regard, in one aspect, an antenna is disclosed. The antenna includes a ground plane comprising an edge and delimiting: an aperture within the edge and a tapered void, the tapered void comprising two bends and a transmission line node.

In another aspect, a wireless communication device is disclosed. The wireless communication device includes a transceiver and an antenna coupled to the transceiver. The antenna comprises a ground plane comprising an edge and delimiting: an aperture within the edge and a tapered void, the tapered void comprising two bends and a transmission line node.

In another aspect, a method of receiving a signal using a folded horn antenna, comprising capturing a signal impinging on an aperture of the folded horn antenna, routing the signal along a folded path including two curves, matching impedance using an inductor, and coupling the signal to a transmission line.

### BRIEF DESCRIPTION OF THE DRAWINGS

FIG. 1 is a top plan view of a conventional Vivaldi horn antenna;

FIG. 2 is a top plan view of a folded horn antenna according to aspects of the present disclosure;

FIGS. 3A-3D illustrate variations of the folded horn antenna of the present disclosure;

FIG. 4 shows a radiation impedance transform for the antenna of FIG. 2;

FIG. 5 is an exploded view of the antenna of FIG. 2, highlighting a balun that may be used with the antenna to transform from a differential signal to a single-ended signal;

FIG. 6A is an exemplary use case for two folded horn antennas according to aspects of the present disclosure;

FIG. 6B is a close-up of the horn antenna portion of FIG. 6A;

FIG. 7 is a flowchart for using a folded horn antenna according to aspects of the present disclosure; and

FIG. 8 is a block diagram of a wireless communication device that may include a folded horn antenna according to the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that although the terms first, second, etc. may be used herein to describe various elements, these elements should not be limited by these terms. These terms are only used to distinguish one element from another. For example, a first element could be termed a second element, and similarly, a second element could be termed a first element without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element, or intervening elements may also be present. In contrast, when an element is referred to as being “directly on” or extending “directly onto” another element, no intervening elements are present. Likewise, it will be understood that when an element such as a layer, region, or substrate is referred to as being “over” or extending “over” another element, it can be directly over or extend directly over the other element, or intervening elements may also be present. In contrast, when an element is referred to as being “directly over” or extending “directly over” another element, no intervening elements are present. It will also be understood that when an element is referred to as being “connected” or “coupled” to another element, it can be directly connected or coupled to the other element, or intervening elements may be present. In contrast, when an element is referred to as being “directly connected” or “directly coupled” to another element, no intervening elements are present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In keeping with the above admonition about definitions, the present disclosure uses transceiver in a broad manner. Current industry literature uses “transceiver” in two ways. The first way uses transceiver broadly to refer to a plurality of circuits that send and receive signals. Exemplary circuits may include a baseband processor, an up/down conversion circuit, filters, amplifiers, couplers, and the like coupled to one or more antennas. A second way, used by some authors in the industry literature, refers to a circuit positioned between a baseband processor and a power amplifier circuit as a transceiver. This intermediate circuit may include the up/down conversion circuits, mixers, oscillators, filters, and the like but generally does not include the power amplifiers. As used herein, the term transceiver is used in the first sense. Where relevant to distinguish between the two definitions, the terms “transceiver chain” and “transceiver circuit” are used respectively.

Additionally, to the extent that the term “approximately” is used in the claims, it is herein defined to be within five percent (5%).

Before addressing the aspects of the present disclosure, a bit more context is provided in the form of a brief discussion of the commercial pressures on wireless communication devices and the antennas. Specifically, there is an industry-wide pressure to reduce the size of any and all components associated with the wireless communication device. Concurrently, there is pressure to provide wireless communication devices that work at a variety of frequency bands. Ultra-wideband (UWB) is one such frequency band and may extend from around 600 MHz to around 10 GHz, with individual channels being in the tens of megahertz. UWB has applications in a variety of spaces, including automotive applications. Some of these spaces will use UWB to do angle of arrival (AoA) measurements, which may compare signal phases between different antennas. Still other spaces may rely on multiple-input multiple-output (MIMO) techniques to achieve desired results. Such MIMO techniques generally rely on multiple antennas. The pressure to use multiple antennas, coupled with the pressure to reduce the overall size, creates competing criteria for designers.

Aspects disclosed in the detailed description include a folded edge horn antenna. In particular, a traditional Vivaldi horn antenna may be fitted into a smaller space by folding the tapered void of the horn antenna. Further, the folded horn antenna may be positioned inside the boundaries of a ground plane such that an edge of the ground plane acts to extend an effective aperture of the antenna, thereby expanding the frequency range over which the antenna may operate.

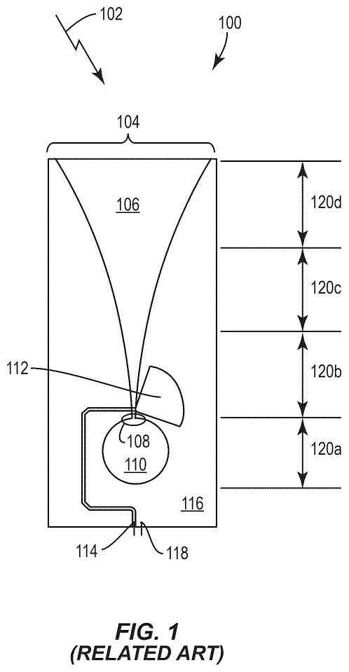

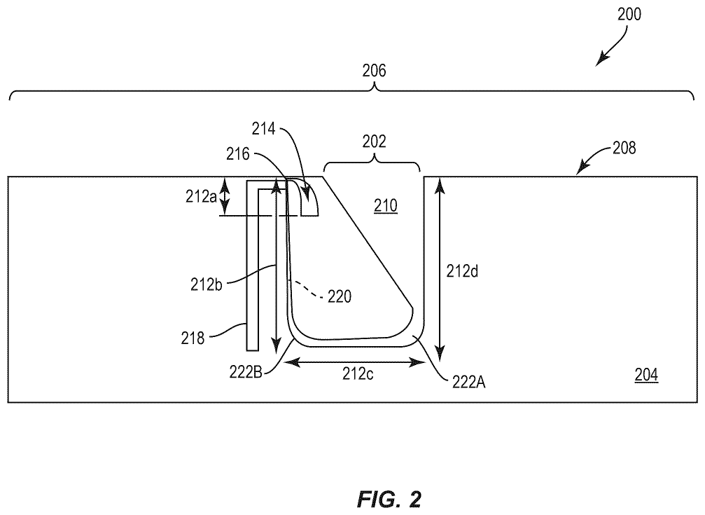

Before addressing aspects of the present disclosure, a brief overview of a conventional Vivaldi horn antenna is provided with reference to FIG. 1. A discussion of aspects of the present disclosure begins below with reference to FIG. 2.

In this regard, FIG. 1 illustrates a top plan view of a Vivaldi horn antenna 100. The horn antenna 100 is, in essence, an impedance transformer for signals 102 propagating through air that impinge on an aperture 104 of the horn antenna 100. The aperture 104 is the beginning of a void 106 that tapers from the relatively wide aperture 104 down to a narrow portion 108. The narrow portion 108 feeds into a second void 110 that acts as an inductor. The inductance of the inductor formed by the second void 110 is essentially a linear function of the circumference of the second void 110. A fan capacitor 112 may also be present and coupled to a first transmission line node 114. The voids 106 and 110 are delimited by a conductive material 116, which is coupled to a second transmission line node 118. The size of the void 106 dictates the impedance transformation, but a typical transformation is from 377 ohms (average characteristic impedance of air at the frequencies of interest) to 50 ohms (typical transmission line impedance).

FIG. 1 also illustrates zones 120a-120d. Zone 120a corresponds to the inductor of second void 110. Zone 120b corresponds to the narrow part of the throat. Zone 120c corresponds to the mid part of the throat (neither exceptionally narrow nor exceptionally wide), and zone 120d corresponds to the wide part of the throat.

A classic horn antenna, such as horn antenna 100, consumes relatively large amounts of space, with the throat being approximately a quarter wavelength of the lowest frequency. Given the size pressures outlined above, there is pressure to make the antennas smaller so that more antennas can be packed into the same amount of space.

Aspects of the present disclosure take a horn antenna and fold it along its edge to create a smaller footprint and, at the same time, actually increase the operational bandwidth of the antenna. While particularly useful in UWB applications and/or automotive applications, the present disclosure is not so limited and may used for other wireless technologies such as cell phones, Wi-Fi, Bluetooth, or the like.

In this regard, FIG. 2 illustrates a folded horn antenna 200 according to a first aspect of the present disclosure. The folded horn antenna 200 includes an aperture 202 in a conductive ground plane 204. Note that the effective aperture size is actually an extended aperture opening 206 defined by the length of an edge 208 of the ground plane 204. The aperture 202 is the beginning of a void 210 in the ground plane 204. The void 210 tapers, in this case linearly, through zone 212d (approximately) in a direction perpendicular to the edge 208. The taper continues into zone 212c, but the void 210 curls or folds ninety degrees so that the void travels in a direction parallel to the edge 208 for the zone 212c. The void 210 then curls or folds another ninety degrees into zone 212b again perpendicular to the edge 208, but this time extending towards the edge 208.

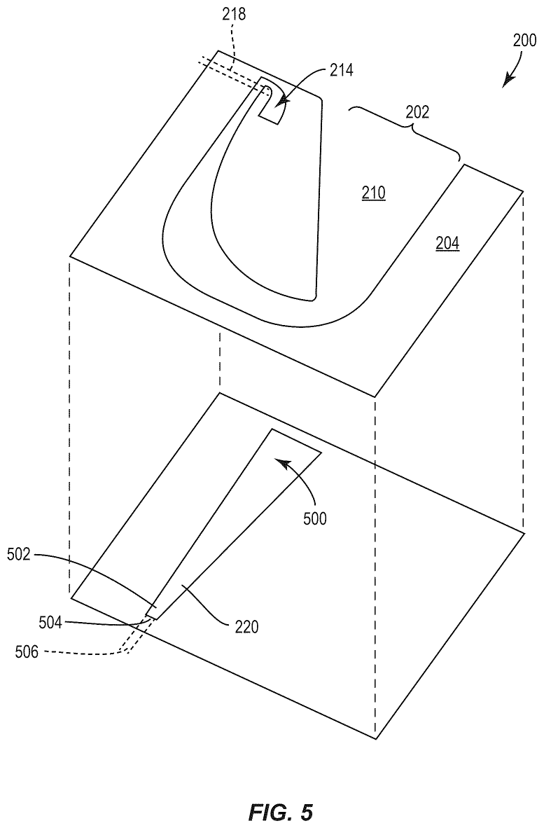

With continued reference to FIG. 2, a second void 214 forms an inductor in zone 212a. A transmission line node 216 is provided proximate the second void 214 for transmission line 218 to couple to the ground plane 204. A balun 220 is marginally visible in FIG. 2 (and better seen in FIG. 5) through the void 210 and provides a second transmission line node (not shown explicitly in FIG. 2).

Note that the folding creates corners 222A, 222B. The degree of curvature for the corners 222A, 222B may be varied based on the space constraints, desired performance, or the like. Note that ninety-degree corners may generate unwanted reflections.

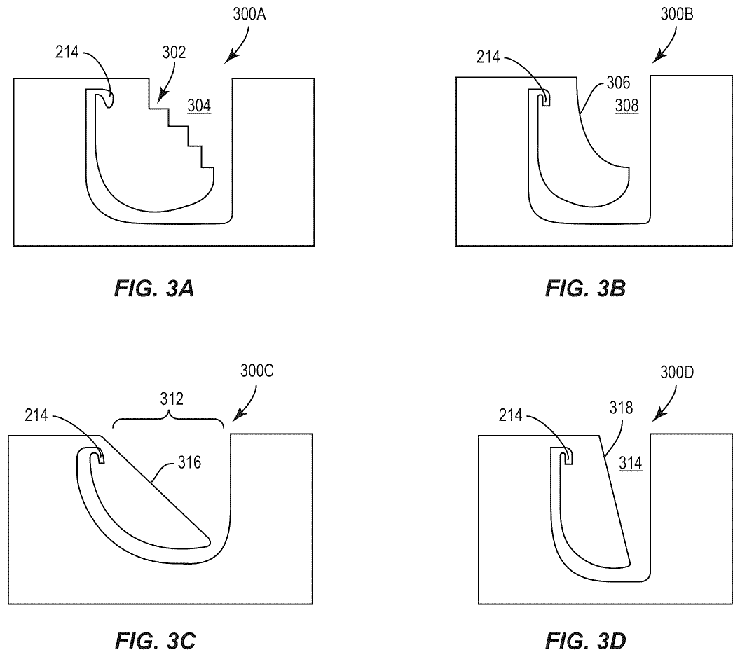

Note that while FIG. 2 illustrates a linear zone 212a, the present disclosure is not so limited. FIGS. 3A-3D provide variations of antennas 300A-300D that may be used depending on various design constraints or considerations. In FIG. 3A, the taper 302 of a void 304 is stepped. In FIG. 3B, the taper 306 of a void 308 is logarithmic. Still other shapes are possible and may be selected based on performance criteria as needed or desired.

Further, the size of the void may be varied as illustrated in FIGS. 3C and 3D. In FIG. 3C, the aperture 312 is relatively wide compared to the aperture 314 of FIG. 3D. While both tapers 316, 318 are linear, it should be appreciated that stepped, logarithmic, or the like may be used with such aperture variation.

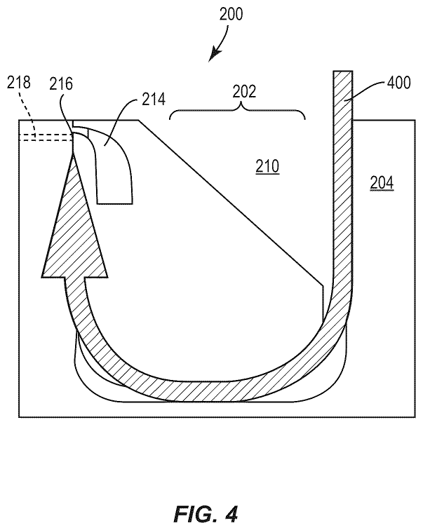

FIG. 4 provides another view of the horn antenna 200 but highlights how signals are received. In particular, a signal 400 enters the aperture 202 and curves around through the void 210 to the inductor formed by the second void 214. The signal will create a signal in the conductive material of the ground plane 204, and this will be available at the transmission line node 216.

FIG. 5 provides additional details about the balun 220 that is in a second plane parallel to a plane in which the ground plane 204 is found. The balun 220 is a tapered transmission line that starts wide at a first end 500 and narrows to a narrow end 502 at a transmission line node 504, where transmission line 506 attaches. The use of a balun 220 allows for transformation from a differential signal to a single-ended signal. Such tapered baluns are well understood in the industry.

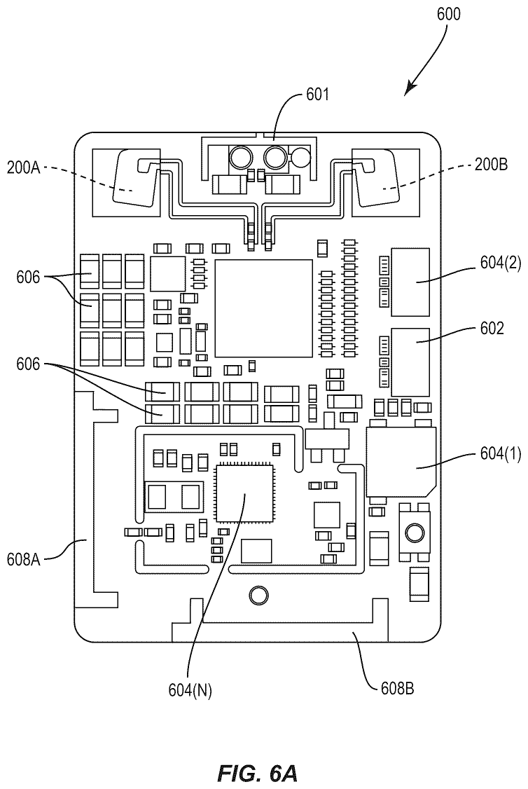

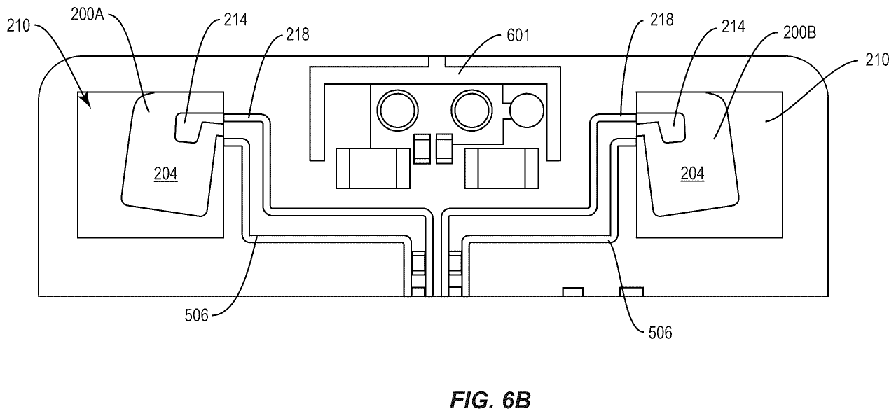

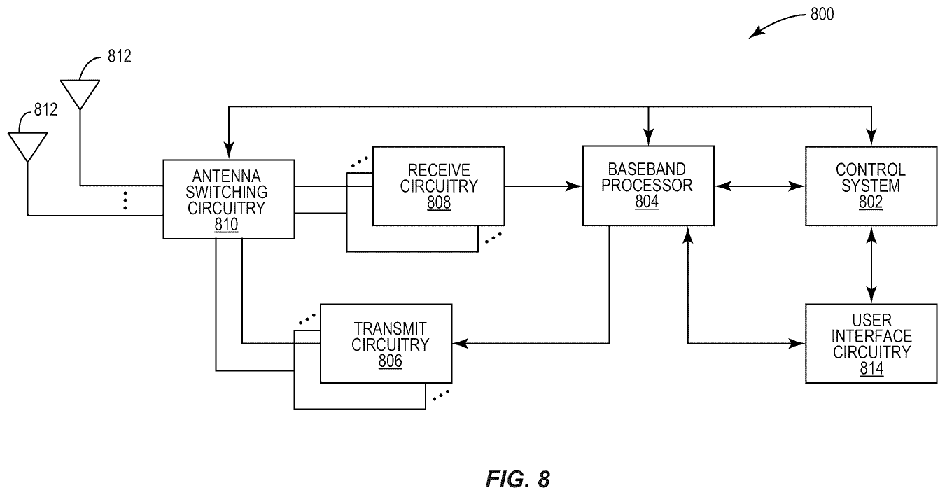

FIGS. 6A & 6B provide an exemplary use case of a key fob 600 for the horn antennas of the present disclosure, with FIG. 6B being an enlarged version of a portion of FIG. 6A. In particular, the key fob 600 may include a first folded horn antenna 200A and a second folded horn antenna 200B separated by an edge-enabled void isolator 601. A control circuit 602 may be positioned on a substrate and provide a transceiver therein (described in greater detail below with reference to FIG. 8). Various other circuits or chips 604(1)-604(N) may also be positioned on the substrate along with surface-mounted devices 606 and additional F antennas 608A, 608B. Still other elements may be present. FIG. 6B is included to show that the elements of the folded horn antenna 200 are present in horn antennas 200A, 200B.

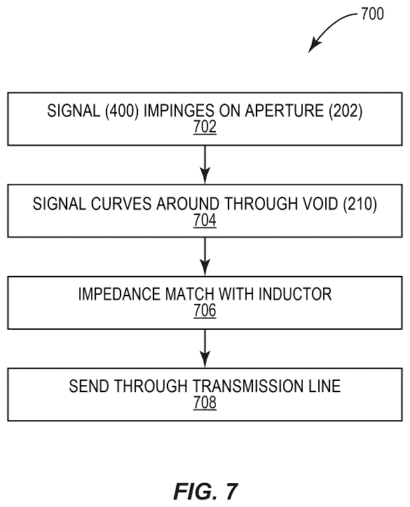

FIG. 7 provides a flowchart of a process 700 for using a folded horn antenna 200. A signal 400 impinges on the aperture 202 (block 702) and curves around through the void 210 (block 704). An inductor formed by the second void 214 provides an impedance match for the signal (block 706), and the signal exits through a transmission line (block 708).

The folded horn antenna, according to aspects disclosed herein, may be provided in or integrated into any wireless communication device. Examples, without limitation, include a set-top box, an entertainment unit, a navigation device, a communications device, a fixed location data unit, a mobile location data unit, a global positioning system (GPS) device, a mobile phone, a cellular phone, a smartphone, a session initiation protocol (SIP) phone, a tablet, a phablet, a server, a computer, a portable computer, a mobile computing device, a wearable computing device (e.g., a smartwatch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

FIG. 8 is a schematic diagram of an exemplary communication device 800 wherein the folded horn antenna 200 can be provided. Herein, the communication device 800 can be any type of communication device, such as those listed above as well as access points, base stations (e.g., eNB or gNB), and any other type of wireless communication devices that support wireless communications, such as cellular, wireless local area network (WLAN), Bluetooth, Ultra-wideband (UWB), and near field communications.

More particularly, the communication device 800 will generally include a control system 802, a baseband processor 804, transmit circuitry 806, receive circuitry 808, antenna switching circuitry 810, multiple antennas 812 (e.g., horn antennas 200), and user interface circuitry 814. In a non-limiting example, the control system 802 can be a field-programmable gate array (FPGA) or an application-specific integrated circuit (ASIC), as an example. In this regard, the control system 802 can include at least a microprocessor(s), an embedded memory circuit(s), and a communication bus interface(s). The receive circuitry 808 receives radio frequency signals via the antennas 812 and through the antenna switching circuitry 810 from one or more base stations. A low noise amplifier and a filter of the receive circuitry 808 cooperate to amplify and remove broadband interference from the received signal for processing. Downconversion and digitization circuitry (not shown) will then downconvert the filtered, received signal to an intermediate or baseband frequency signal, which is then digitized into one or more digital streams using an analog-to-digital converter(s) (ADC).

The baseband processor 804 processes the digitized received signal to extract the information or data bits conveyed in the received signal. This processing typically comprises demodulation, decoding, and error correction operations. The baseband processor 804 is generally implemented in one or more digital signal processors (DSPs) and ASICs.

For transmission, the baseband processor 804 receives digitized data, which may represent voice, data, or control information, from the control system 802, which it encodes for transmission. The encoded data is output to the transmit circuitry 806, where a digital-to-analog converter(s) (DAC) converts the digitally encoded data into an analog signal, and a modulator modulates the analog signal onto a carrier signal that is at a desired transmit frequency or frequencies. A power amplifier will amplify the modulated carrier signal to a level appropriate for transmission and deliver the modulated carrier signal to the antennas 812 through the antenna switching circuitry 810. The multiple antennas 812 and the replicated transmit and receive circuitries 806, 808 may provide spatial diversity. Modulation and processing details will be understood by those skilled in the art.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications, as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein but is to be accorded the widest scope consistent with the principles and novel features disclosed herein.

What is claimed is:

1. An antenna comprising:
a ground plane comprising an edge and delimiting:
an aperture within the edge; and
a tapered void, the tapered void comprising two bends and a transmission line node.

2. The antenna of claim 1, wherein the tapered void comprises:
a first zone perpendicular to the edge;
a second zone parallel to the edge and perpendicular to the first zone, a first one of the two bends marking a transition between the first zone and the second zone; and
a third zone perpendicular to the edge, a second one of the two bends marking a transition between the second zone and the third zone.

3. The antenna of claim 1, further comprising a second void configured to operate as an inductor, the second void coupled to the tapered void.

4. The antenna of claim 1, further comprising a balun positioned in a second plane parallel to the ground plane.

5. The antenna of claim 4, wherein the balun comprises a tapered transmission line.

6. The antenna of claim 4, wherein the balun comprises a second transmission line node.

7. The antenna of claim 2, wherein the tapered void comprises a linear taper in the first zone.

8. The antenna of claim 2, wherein the tapered void comprises a stepped taper in the first zone.

9. The antenna of claim 2, wherein the tapered void comprises a logarithmic taper in the first zone.

10. The antenna of claim 1, wherein the antenna is configured to operate between approximately 600 MHz and 10 GHz.

11. A wireless communication device comprising:
a transceiver;
an antenna coupled to the transceiver, the antenna comprising:
a ground plane comprising an edge and delimiting:
an aperture within the edge; and
a tapered void, the tapered void comprising two bends and a transmission line node.

12. The wireless communication device of claim 11, further comprising a second antenna.

13. The wireless communication device of claim 12, further comprising an edge-enabled void isolator (EEVI) positioned between the antenna and the second antenna.

14. The wireless communication device of claim 11, wherein the tapered void comprises:
a first zone perpendicular to the edge;
a second zone parallel to the edge and perpendicular to the first zone, a first one of the two bends marking a transition between the first zone and the second zone; and
a third zone perpendicular to the edge, a second one of the two bends marking a transition between the second zone and the third zone.

15. A method of receiving a signal using a folded horn antenna, the method comprising:
capturing a signal impinging on an aperture of the folded horn antenna;
routing the signal around two curves;
matching impedance with an inductor; and
coupling the signal to a transmission line.

16. The method of claim 15, wherein impedance matching with the inductor comprises matching with an inductor formed from a void.

17. The method of claim 15, wherein routing the signal around two curves comprises routing the signal around two generally right-angle curves.
